(19) United States
(12) Patent Application Publication
(10) Pub. No.: US 2007/0109216 A1
(43) Pub. Date: May 17, 2007

(54) Etthernet Video Input Output

(75) Inventor: Scott James McGowan, Kirkland, WA (US)

Correspondence Address: Scott J. McGowan, 12111 NE 149th St.,, Kirkland, WA, 98034, US

(73) Assignee: Scott James McGowan, Kirkland, WA (US)

(21) Appl. No.: 11/164,166

(22) Filed: Nov. 13, 2005

(51) Int. Cl. G09G 5/00; G06F 13/38

(52) U.S. Cl. 345/2.1; 710/73

(57) ABSTRACT

Multi Internet Video Card is a multiple output video card and multiple keyboard/mouse input port circuitry design provides a low cost method for creating three video outputs and two additional sets of keyboard/mouse input ports. A software driver acts as a port handler for the extra keyboard/mice. A modified custom internet browser code variant is compiled to create a version for station one, and another custom version for station two. These modified browsers only look for extra user keyboard and extra mouse input from the additional stations they are assigned to. Costly support software as operating systems and Internet firewalls are needed only for the one system. Costly system maintenance need only be done for the one system that can provide internet stations for three users. Costly maintenance support is now needed only for one system. Management of secondary users browsing habits and rules are controlled by the master user.

The Multi Internet Video Card is a video card 204 and keyboard/mouse input port circuitry design provides a low cost method for creating three 100 video outputs and two additional sets of keyboard/mouse input ports 101, for the purpose of operating three internet browser stations 103, 203 in a pseudo multi-user fashion.

A software driver 200 adds additional computer software code that acts as a port handler for the keyboard/mouse ports 200. This software code works with a video driver code that has been modified to share the video controller chip's (integrated circuit's) 12C ports, in order to multiplex that 12C port 102.

The original intent of the video controller chip's 12C port is only for communication to an external CRT or Flat Panel Display for passing configuration information 102. However this design multiplex's the 12C port and uses it also as a communication pathway for the additional keyboard/mouse ports that create additional stations for internet browsing.

A modified internet browser code 201 is compiled to create a version for station 1, and another custom version 201 for station 2. An un-modified software application browser is used for the master user 202. These modified browsers only look for user input from the additional stations they belong to, except for the master keyboard and mouse which can cause those browsers to exit and shut down. All of the keyboards and mice are normal unmodified common components.

This system dramatically lowers the cost of purchasing and maintaining multiple Internet stations versus the concept of “one personal computer for one internet station”. Costly support software such as operating systems and Internet firewalls need only be purchased for the one system. Costly hardware or software Internet routers are not required to provide multiple internet station function. Costly maintenance support is now needed only for one system. Management of secondary users browsing habits and rules are easily controlled and monitored by the mater user.

This system is not a true multi-user system, but a pseudo multi-user. Specifically it is a multiple internet browser user system 201, by way of customized applications that look for user input only from the custom keyboard and mouse driver 200, that look only for hardware keyboard and mouse signals that come from the video card.

### DESCRIPTION OF THE PREFERRED EMBODIMENTS

Invention embodies expanded intended use of Laptop PC or desktop PC video controller chips to achieve three display screen outputs and two additional keyboard and mouse input ports by multiplexing the video controller's 12C ports. The unconventional and novel use of the 12C port to be multiplexed and translated to standard keyboard and standard mouse ports for extra keyboards and mice to be attached to the personal computer, without incurring the additional costs of a FPGA circuit for a PCI bus connection

Invention embodies two copies of a customized browser to use only the keyboard and mouse inputs associated with the additional Internet stations. The Invention embodies small graphic images that appear as program launch bars on the secondary Internet displays.

The secondary Internet stations can launch their own browsers from those small graphic launch bars. A FPGA (field programmable gate array) integrated circuit contains the low cost multiplexing digital circuits that make a single hardware 12C port that is on the video controller IC act as multiple keyboard/mice ports.

The invention embodies a software driver program that translates extra keyboards and mice input signals via the converted 12C port to a usable format that the customized programs can use. The personal computer still retains is standard keyboard and mouse and standard keyboard and mouse software drivers, so that all regular “single user” programs, see no changes in behavior, and still get keyboard and mouse input only from the master keyboard and master mouse.

### LIST OF DRAWINGS

FIG. 1: Video Card w/Multiple Displays and Multiple Keyboards and Mouse Inputs.

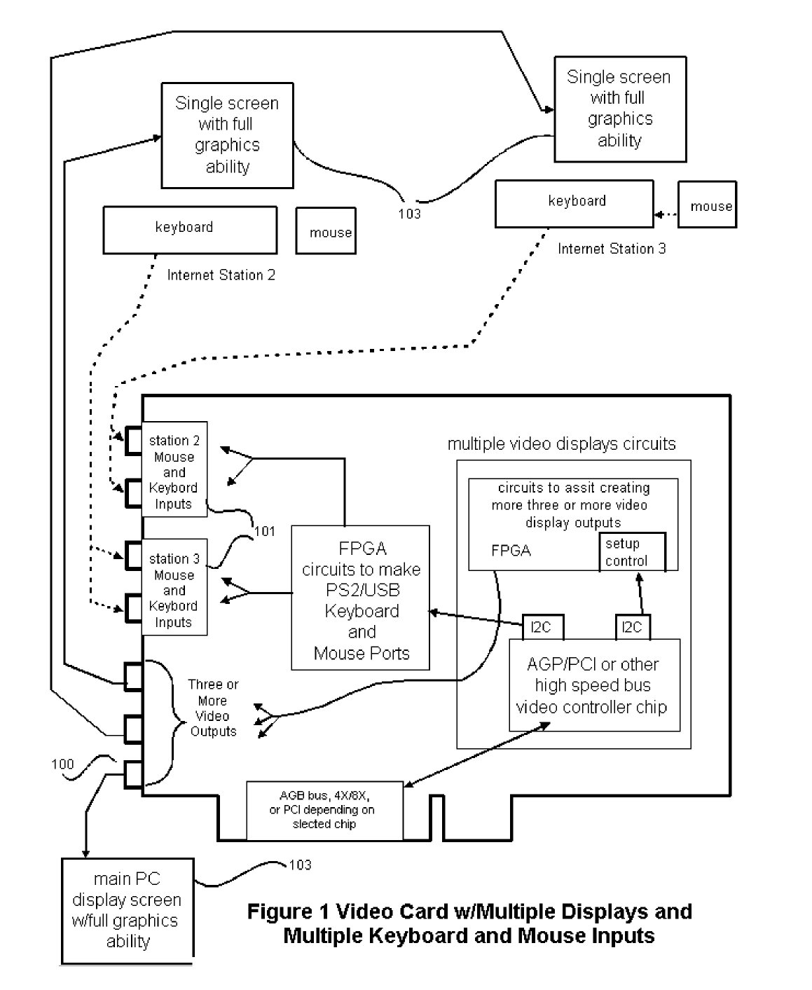

FIG. 2: Customized Software Browsers, and Software Applications for Custom keyboard and Custom Mouse Inputs.

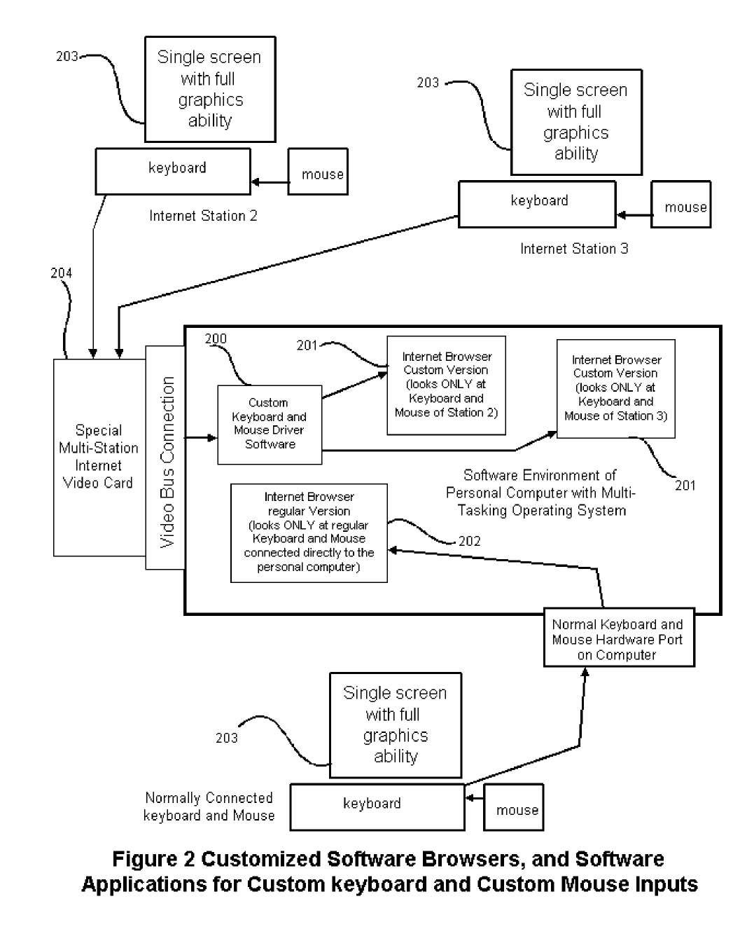

### SUMMARY OF INVENTION

Keeping system costs low and system installation simple is a critical priority for this three person internet browsing system. Multi-tasking operating systems for a single user are common. Also there is a large world wide base of persons with knowledge how to obtain and install those single user operating systems on common personal computers. This system uses a single personal computer and a single installed copy of the multi-tasking operating system.

Multi Internet Video Card is a combination of a unique electronic design, custom keyboard and mouse driver and custom user application software that resides on a common personal computer and a common multitasking operating system. Normally a personal computer with a common multitasking operating system can support the one internet surfing person at a point in time. The purpose of this system is to provide three stations (three screens, three keyboards and three mice) for three simultaneous internet using persons.

This system uses a custom video card with three video screen outputs and also having inputs for two additional keyboards and two additional mice. This hardware video card is combined with a custom keyboard and mouse driver for the extra two keyboards and mice, to produce the user input data for the two screens showing customized internet browser variants, that look only for keyboard and mouse inputs from the custom driver, that handles the keyboards and mice connected to this novel hardware video card.

In addition to the custom browsers for pseudo users two and three (the master user is user one), there can be custom application software that appears on screens two and three as personal task bars. These personal task bars may contain he application program icons to launch customized word processors, customized spread sheets, customized text editors, customized calculators and other programs that are of common need, thus providing not only pseudo multi-internet stations, but closer to being pseudo multi-general-purpose stations.

The master station (station one) has a software menu that launches task bar programs for the pseudo multi-general-purpose stations two and three. The control software for the master station may also contain size compressed real time images of the pseudo user screens of the two pseudo stations for the purpose of parental control of children's use of the computer programs and or internet surfing. This system can also be used in environments such as prisons, where internet or computer use may be offered to inmates to assisting them in education, family contact and legal work etc, but where close monitoring by a supervisor is required.

What is claimed is:

1. A unique multi internet video card is a multiple video output video card and multiple keyboard/mouse input port circuitry, of one count less than the video outputs, as a low cost method for creating multiple video outputs and additional sets of keyboard/mouse input ports.

2. Unique multiple internet stations do not comprise a true “multi-user” system, but a run on a single multi-tasking operating system as customized application programs, creating multiple pseudo internet user outputs directed to the assigned video output and looking at user input only from the assigned extra keyboard and assigned extra mouse, whereas the operating system cannot track or manage different users, but sees all internet history use as one user.

3. A novel multi internet video card as in claim 1, creates two the additional keyboard and mouse inputs via multiplexing one or more the 12C serial data ports that come as standard ports on video controller integrated circuits, with additional software driver program that handles the port hardware to make the multiple extra keyboards and multiple extra mice data flow available to the customized variants of the internet browsers.

4. A novel custom program, launched by the master station, is available for each extra user screen that appears to that extra user as a personal extra user task-bar, that seeks input from the extra keyboards and mice, that contains the program launch icons for various customized programs, that have been customized to provide pseudo multi-user programs for common needs such as word processing, text editors, spread sheets and video players.

5. A novel software program as in claim 4 that is launched by the master user that can real-time visually monitor the computer use activities of the extra users.

6. Novel multiple stations as in claim 2, provide to extra users using this pseudo multi user system, additional customized programs such as word processors, calculators, and video players that look only for mouse and keyboard input from the custom keyboard and mouse driver handling the extra keyboards and mice.

7. Novel multiple stations as in claim 2, as another cost lowing option, shall use customized programs that have sound output, will logically share hardware stereo channel 2 output, as monophonic sound, whereas the master user sound out put from his/her programs has been intercepted by a software filter driver, changing that sound flow from stereo into channel 1 monophonic sound flow.

8. Unique multiple stations as in claim 2, as slightly higher cost option, will use additional hardware sound circuits providing additional hardware sound channels that may be on the same video card or separate card, as the additional sound hardware channels for the sound flows for the extra users programs that have sound output.
